(19) United States
(12) Patent Application Publication
(10) Pub. No.: US 2014/0256247 A1
(43) Pub. Date: Sep. 11, 2014

(54) DYNAMIC INTERFACE SELECTION IN A MOBILE DEVICE

(71) Applicant: QUALCOMM Incorporated, San Diego, CA (US)

(72) Inventor: Richard Dominic WIETFELDT, San Diego, CA (US)

(73) Assignee: QUALCOMM Incorporated, San Diego, CA (US)

(21) Appl. No.: 14/171,397

(22) Filed: Feb. 3, 2014

Related U.S. Application Data
(60) Provisional application No. 61/772,977, filed on Mar. 5, 2013.

(51) Int. Cl. H04W 4/00

(52) U.S. Cl. CPC H04W 4/00
USPC 455/39

(57) ABSTRACT

A mobile wireless device/platform dynamically selects or instantiates a desired interface to improve conditions related to the mobile (multi-radio) wireless device, such as power consumption savings, radio coexistence mitigation, electromagnetic interference (EMI) reduction, etc. In one instance, the mobile wireless device identifies one or more hardware interfaces in a mobile wireless device host. The mobile wireless device then dynamically selects the one or more hardware interfaces to facilitate communication between a peripheral device and the mobile wireless device host.

### CROSS-REFERENCE TO RELATED APPLICATION

The present application claims the benefit of U.S. Provisional Patent Application No. 61/722,977, filed on Mar. 5, 2013 and titled “Dynamic Interface Selection in a Mobile Device,” the disclosure of which is expressly incorporated by reference herein in its entirety.

### BACKGROUND

1. Field

Aspects of the present disclosure relate generally to interface selection techniques and, more specifically, to dynamic interface selection techniques for mobile devices.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple access systems include code division multiple access (CDMA) systems, time division multiple access (TDMA) systems, frequency division multiple access (FDMA) systems, 3GPP long term evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple out (MIMO) system.

Some conventional advanced devices include multiple radios for transmitting/receiving using different radio access technologies (RATs). Examples of RATs include, e.g., universal mobile telecommunications system (UMTS), global system for mobile communications (GSM), CDMA2000, WiMAX, WLAN (e.g., Wi-Fi), Bluetooth, LTE, and the like.

An example mobile device includes an LTE User Equipment (UE), such as a fourth generation (4G) mobile phone. Such 4G phone may include various radios to provide a variety of functions for the user. For purposes of this example, the 4G phone includes an LTE radio for voice and data, an IEEE 802.11 (Wi-Fi) radio, a global positioning system (GPS) radio, and a Bluetooth radio, where two of the above or all four may operate simultaneously. While the different radios provide useful functionalities for the phone, their inclusion in a single device gives rise to coexistence issues. Specifically, operation of one radio may in some cases interfere with operation of another radio through radiative, conductive, resource collision, and/or other interference mechanisms. Coexistence issues include such interference.

This is especially true for the LTE uplink channel, which is adjacent to the industrial scientific and medical (ISM) band and may cause interference therewith. It is noted that Bluetooth and some wireless LAN (WLAN) channels fall within the ISM band. In some instances, a Bluetooth error rate can become unacceptable when LTE is active in some channels of Band 7 or even Band 40 for some Bluetooth channel conditions. Even though there is no significant degradation to LTE, simultaneous operation with Bluetooth can result in disruption in voice services terminating in a Bluetooth headset. Such disruption may be unacceptable to the consumer. A similar issue exists when LTE transmissions interfere with GPS. Currently, there is no mechanism that can solve this issue since LTE by itself does not experience any degradation

With reference specifically to LTE, it is noted that a UE communicates with an evolved NodeB (eNB; e.g., a base station for a wireless communications network) to inform the eNB of interference seen by the UE on the downlink. Furthermore, the eNB may be able to estimate interference at the UE using a downlink error rate. In some instances, the eNB and the UE can cooperate to find a solution that reduces interference at the UE, even interference due to radios within the UE itself. However, in conventional LTE, the interference estimates regarding the downlink may not be adequate to comprehensively address interference.

In one instance, an LTE uplink signal interferes with a Bluetooth signal or WLAN signal. However, such interference is not reflected in the downlink measurement reports at the eNB. As a result, unilateral action on the part of the UE (e.g., moving the uplink signal to a different channel) may be thwarted by the eNB, which is not aware of the uplink coexistence issue and seeks to undo the unilateral action. For instance, even if the UE re-establishes the connection on a different frequency channel, the network can still handover the UE back to the original frequency channel that was corrupted by the in-device interference. This is a likely scenario because the desired signal strength on the corrupted channel may sometimes be higher than reflected in the measurement reports of the new channel based on Reference Signal Received Power (RSRP) to the eNB. Hence, a ping-pong effect of being transferred back and forth between the corrupted channel and the desired channel can happen if the eNB uses RSRP reports to make handover decisions.

Other unilateral action on the part of the UE, such as simply stopping uplink communications without coordination of the eNB may cause power loop malfunctions at the eNB. Additional issues that exist in conventional LTE include a general lack of ability on the part of the UE to suggest desired configurations as an alternative to configurations that have coexistence issues. For at least these reasons, uplink coexistence issues at the UE may remain unresolved for a long time period, degrading performance and efficiency for other radios of the UE.

### SUMMARY

According to one aspect of the present disclosure, a method for wireless communication includes identifying one or more hardware interfaces in a mobile wireless device host. The method also includes dynamically selecting the one or more hardware interfaces to facilitate communication between a peripheral device and the mobile wireless device host.

According to another aspect of the present disclosure, an apparatus for wireless communication includes means for identifying one or more hardware interfaces in a mobile wireless device host. The apparatus also includes means for dynamically selecting the one or more hardware interfaces to facilitate communication between a peripheral device and the mobile wireless device host.

According to one aspect of the present disclosure, an apparatus for wireless communication includes a memory and a processor(s) coupled to the memory. The processor(s) is configured to identify one or more hardware interfaces in a mobile wireless device host. The processor(s) is also configured to dynamically select the one or more hardware interfaces to facilitate communication between a peripheral device and the mobile wireless device host.

According to one aspect of the present disclosure, a computer program product for wireless communication in a wireless network includes a computer-readable medium having non-transitory program code recorded thereon. The program code includes program code to identify one or more hardware interfaces in a mobile wireless device host. The program code also includes program code to dynamically select the one or more hardware interfaces to facilitate communication between a peripheral device and the mobile wireless device host.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates a multiple access wireless communication system according to one aspect.

FIG. 2 is a block diagram of a communication system according to one aspect.

FIG. 3 illustrates an exemplary frame structure in downlink Long Term Evolution (LTE) communications.

FIG. 4 is a block diagram conceptually illustrating an exemplary frame structure in uplink Long Term Evolution (LTE) communications.

FIG. 5 illustrates an example wireless communication environment.

FIG. 6 is a block diagram of an example design for a multi-radio wireless device.

FIG. 7 is graph showing respective potential collisions between seven example radios in a given decision period.

FIG. 8 is a diagram showing operation of an example Coexistence Manager (C×M) over time.

FIG. 9 is a block diagram illustrating adjacent frequency bands.

FIG. 10 illustrates a mobile wireless device including a host coupled to wireless modems according to one aspect of the present disclosure.

FIG. 11 is a block diagram illustrating a method for dynamic interface selection in a mobile device according to one aspect of the present disclosure.

FIG. 12 is a block diagram illustrating components for dynamic interface selection in a user equipment according to one aspect of the present disclosure.

### DETAILED DESCRIPTION

Various aspects of the disclosure provide techniques to mitigate coexistence issues in multi-radio devices, where significant in-device coexistence problems can exist between, e.g., the LTE and Industrial Scientific and Medical (ISM) bands (e.g., for BT/WLAN). As explained above, some coexistence issues persist because an eNB is not aware of interference on the UE side that is experienced by other radios. According to one aspect, the UE declares a radio link failure (RLF) and autonomously accesses a new channel or radio access technology (RAT) if there is a coexistence issue on the present channel. The UE can declare a RLF in some examples for the following reasons: 1) UE reception is affected by interference due to coexistence, and 2) the UE transmitter is causing disruptive interference to another radio. The UE then sends a message indicating the coexistence issue to the eNB while reestablishing connection in the new channel or RAT. The eNB becomes aware of the coexistence issue by virtue of having received the message.

The techniques described herein can be used for various wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, etc. The terms “networks” and “systems” are often used interchangeably. A CDMA network can implement a radio technology such as universal terrestrial radio access (UTRA), CDMA2000, etc. UTRA includes wideband-CDMA (W-CDMA) and low chip rate (LCR). CDMA2000 covers IS-2000, IS-95 and IS-856 standards. A TDMA network can implement a radio technology such as global system for mobile communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of universal mobile telecommunication system (UMTS). Long term evolution (LTE) is an upcoming release of UMTS that uses E-UTRA. UTRA, E-UTRA, GSM, UMTS and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in portions of the description below.

Single carrier frequency division multiple access (SC-FDMA), which utilizes single carrier modulation and frequency domain equalization is a technique that can be utilized with various aspects described herein. SC-FDMA has similar performance and essentially the same overall complexity as those of an OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for an uplink multiple access scheme in 3GPP long term evolution (LTE), or Evolved UTRA.

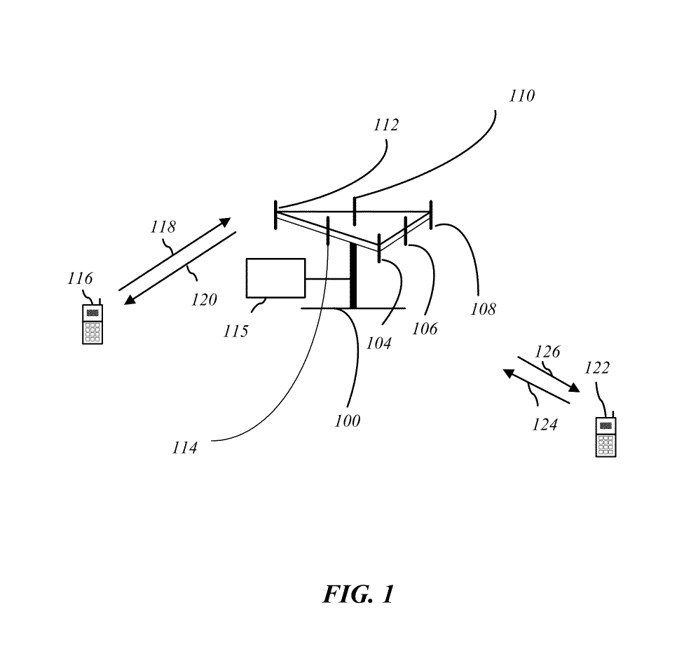

Referring to FIG. 1, a multiple access wireless communication system according to one aspect is illustrated. An evolved Node B 100 (eNB) includes a computer 115 that has processing resources and memory resources to manage the LTE communications by allocating resources and parameters, granting/denying requests from user equipment, and/or the like. The eNB 100 also has multiple antenna groups, one group including antenna 104 and antenna 106, another group including antenna 108 and antenna 110, and an additional group including antenna 112 and antenna 114. In FIG. 1, only two antennas are shown for each antenna group, however, more or fewer antennas can be utilized for each antenna group. A User Equipment (UE) 116 (also referred to as an Access Terminal (AT)) is in communication with antennas 112 and 114, while antennas 112 and 114 transmit information to the UE 116/122 over an uplink (UL) 188. The UE 122 is in communication with antennas 106 and 108, while antennas 106 and 108 transmit information to the UE 122 over a downlink (DL) 126 and receive information from the UE 122 over an uplink 124. In a frequency division duplex (FDD) system, communication links 118, 120, 124 and 126 can use different frequencies for communication. For example, the downlink 120 can use a different frequency than used by the uplink 118.

Each group of antennas and/or the area in which they are designed to communicate is often referred to as a sector of the eNB. In this aspect, respective antenna groups are designed to communicate to UEs in a sector of the areas covered by the eNB 100.

In communication over the downlinks 120 and 126, the transmitting antennas of the eNB 100 utilize beamforming to improve the signal-to-noise ratio of the uplinks for the different UEs 116 and 122. Also, an eNB using beamforming to transmit to UEs scattered randomly through its coverage causes less interference to UEs in neighboring cells than a UE transmitting through a single antenna to all its UEs.

An eNB can be a fixed station used for communicating with the terminals and can also be referred to as an access point, base station, or some other terminology. A UE can also be called an access terminal, a wireless communication device, terminal, or some other terminology.

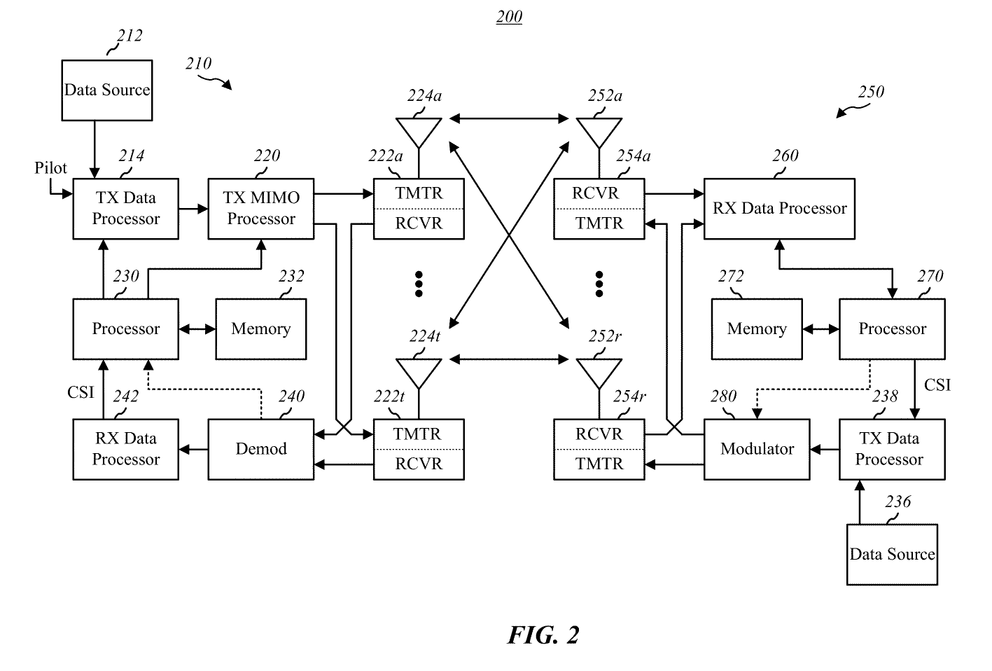

FIG. 2 is a block diagram of an aspect of a transmitter system 210 (also known as an eNB) and a receiver system 250 (also known as a UE) in a MIMO system 200. In some instances, both a UE and an eNB each have a transceiver that includes a transmitter system and a receiver system. At the transmitter system 210, traffic data for a number of data streams is provided from a data source 212 to a transmit (TX) data processor 214.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, wherein N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports time division duplex (TDD) and frequency division duplex (FDD) systems. In a TDD system, the uplink and downlink transmissions are on the same frequency region so that the reciprocity principle allows the estimation of the downlink channel from the uplink channel. This enables the eNB to extract transmit beamforming gain on the downlink when multiple antennas are available at the eNB.

In an aspect, each data stream is transmitted over a respective transmit antenna. The TX data processor 214 formats, codes, and interleaves the traffic data for each data stream based on a particular coding scheme selected for that data stream to provide coded data.

The coded data for each data stream can be multiplexed with pilot data using OFDM techniques. The pilot data is a known data pattern processed in a known manner and can be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream can be determined by instructions performed by a processor 230 operating with a memory 232.

The modulation symbols for respective data streams are then provided to a TX MIMO processor 220, which can further process the modulation symbols (e.g., for OFDM). The TX MIMO processor 220 then provides N_{T} modulation symbol streams to N_{T} transmitters (TMTR) 222a through 222t. In certain aspects, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from the transmitters 222a through 222t are then transmitted from N_{T} antennas 224a through 224t, respectively.

At a receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{R} “detected” symbol streams. The RX data processor 260 then demodulates, deinterleaves, and decodes each detected symbol stream to recover the traffic data for the data stream. The processing by the RX data processor 260 is complementary to the processing performed by the TX MIMO processor 220 and the TX data processor 214 at the transmitter system 210.

A processor 270 (operating with a memory 272) periodically determines which pre-coding matrix to use (discussed below). The processor 270 formulates an uplink message having a matrix index portion and a rank value portion.

The uplink message can include various types of information regarding the communication link and/or the received data stream. The uplink message is then processed by a TX data processor 238, which also receives traffic data for a number of data streams from a data source 236, modulated by a modulator 280, conditioned by transmitters 254a through 254r, and transmitted back to the transmitter system 210.

At the transmitter system 210, the modulated signals from the receiver system 250 are received by antennas 224, conditioned by receivers 222, demodulated by a demodulator 240, and processed by an RX data processor 242 to extract the uplink message transmitted by the receiver system 250. The processor 230 then determines which pre-coding matrix to use for determining the beamforming weights, then processes the extracted message.

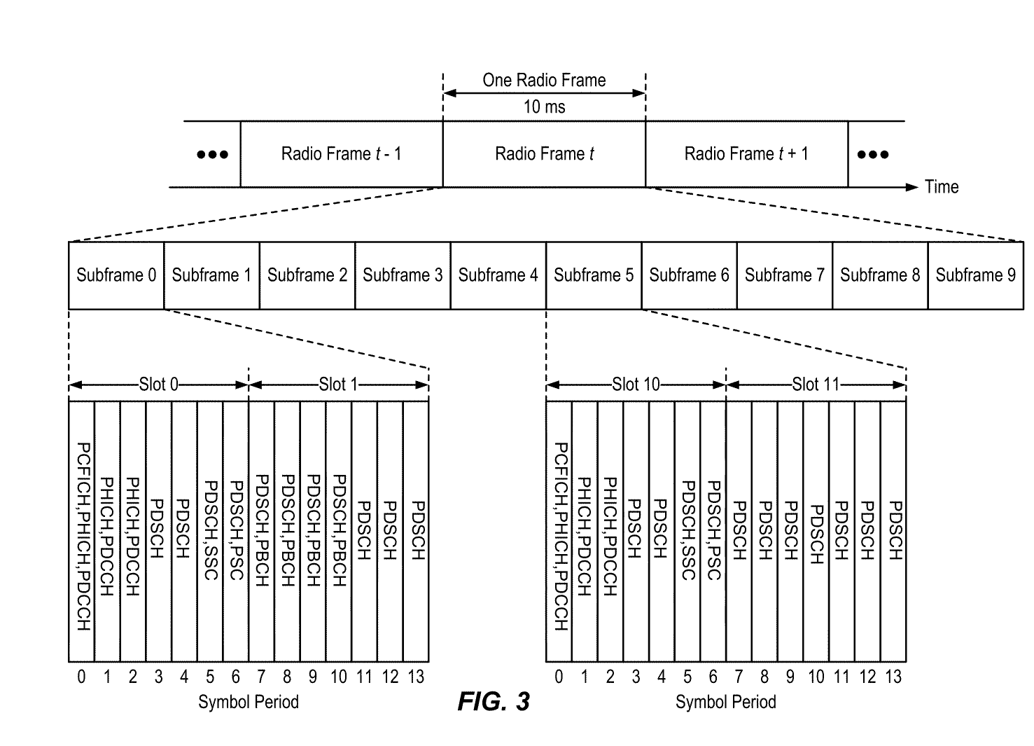

FIG. 3 is a block diagram conceptually illustrating an exemplary frame structure in downlink Long Term Evolution (LTE) communications. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 3) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a Primary Synchronization Signal (PSS) and a Secondary Synchronization Signal (SSS) for each cell in the eNB. The PSS and SSS may be sent in symbol periods 6 and 5, respectively, in each of subframes 0 and 5 of each radio frame with the normal cyclic prefix, as shown in FIG. 3. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Cell-specific Reference Signal (CRS) for each cell in the eNB. The CRS may be sent in symbols 0, 1, and 4 of each slot in case of the normal cyclic prefix, and in symbols 0, 1, and 3 of each slot in case of the extended cyclic prefix. The CRS may be used by UEs for coherent demodulation of physical channels, timing and frequency tracking, Radio Link Monitoring (RLM), Reference Signal Received Power (RSRP), and Reference Signal Received Quality (RSRQ) measurements, etc.

The eNB may send a physical control format indicator channel (PCFICH) in the first symbol period of each subframe, as seen in FIG. 3. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 3, M=3. The eNB may send a physical HARQ indicator channel (PHICH) and a physical downlink control channel (PDCCH) in the first M symbol periods of each subframe. The PDCCH and PHICH are also included in the first three symbol periods in the example shown in FIG. 3. The PHICH may carry information to support hybrid automatic repeat request (HARQ). The PDCCH may carry information on resource allocation for UEs and control information for downlink channels. The eNB may send a physical downlink shared channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

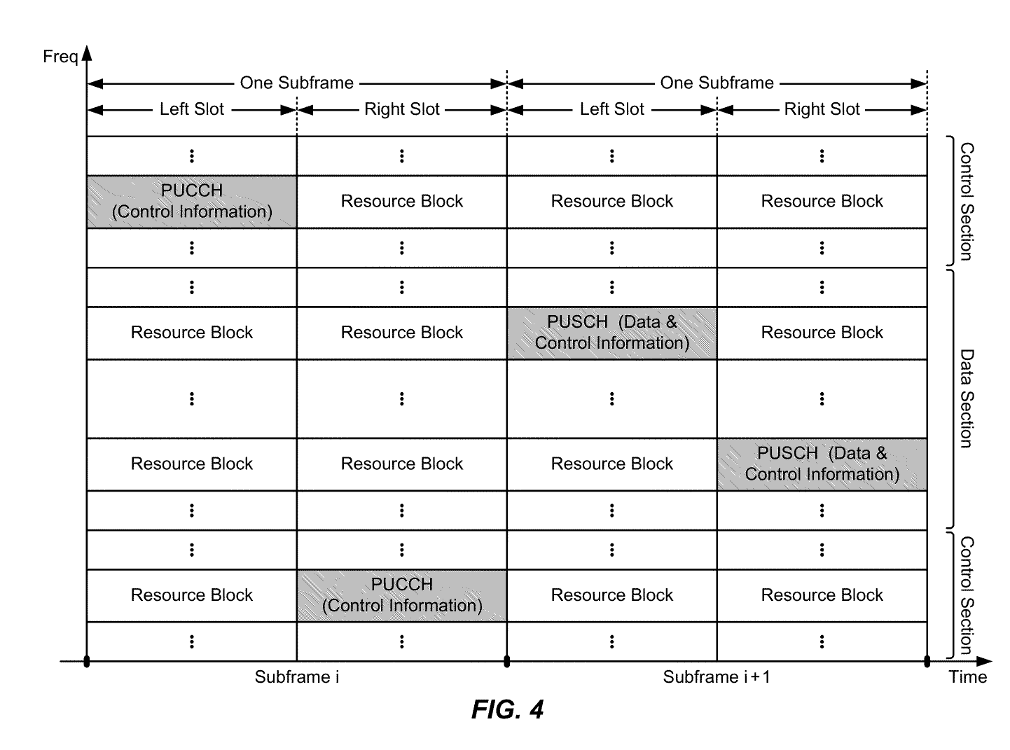

FIG. 4 is a block diagram conceptually illustrating an exemplary frame structure in uplink long term evolution (LTE) communications. The available resource blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 4 results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency as shown in FIG. 4.

The PSS, SSS, CRS, PBCH, PUCCH and PUSCH in LTE are described in 3GPP TS 36.211, entitled “Evolved Universal Terrestrial Radio Access (E-UTRA); Physical Channels and Modulation,” which is publicly available.

In an aspect, described herein are systems and methods for providing support within a wireless communication environment, such as a 3GPP LTE environment or the like, to facilitate multi-radio coexistence solutions.

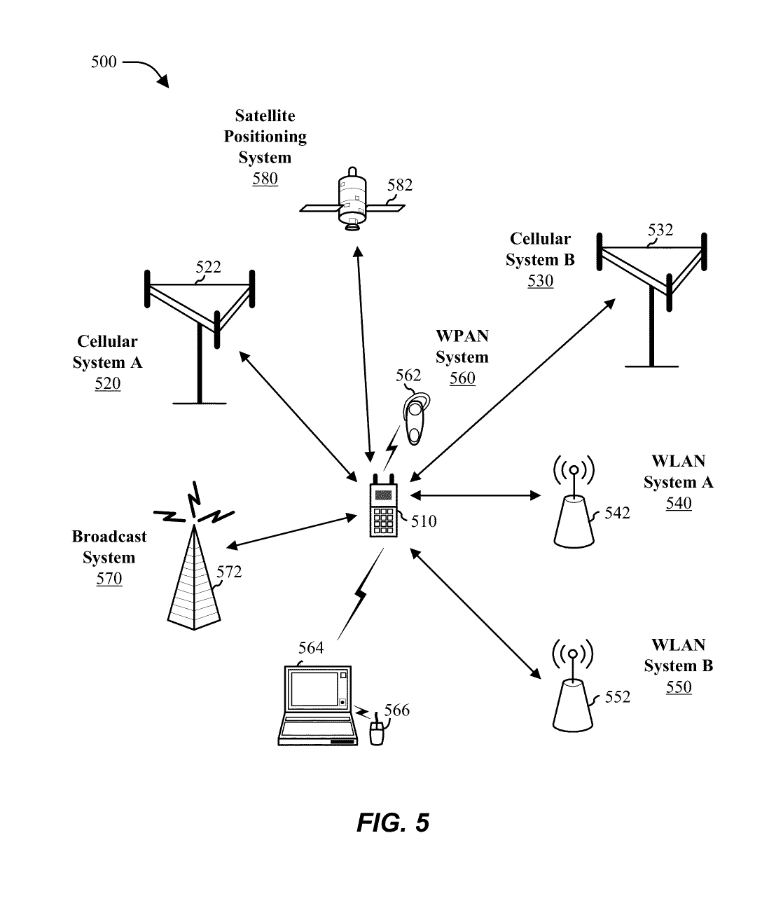

Referring now to FIG. 5, illustrated is an example wireless communication environment 500 in which various aspects described herein can function. The wireless communication environment 500 can include a wireless device 510, which can be capable of communicating with multiple communication systems. These systems can include, for example, one or more cellular systems 520 and/or 530, one or more WLAN systems 540 and/or 550, one or more wireless personal area network (WPAN) systems 560, one or more broadcast systems 570, one or more satellite positioning systems 580, other systems not shown in FIG. 5, or any combination thereof. It should be appreciated that in the following description the terms “network” and “system” are often used interchangeably.

The cellular systems 520 and 530 can each be a CDMA, TDMA, FDMA, OFDMA, single carrier FDMA (SC-FDMA), or other suitable system. A CDMA system can implement a radio technology such as universal terrestrial radio access (UTRA), CDMA2000, etc. UTRA includes wideband CDMA (WCDMA) and other variants of CDMA. Moreover, CDMA2000 covers IS-2000 (CDMA2000 1X), IS-95 and IS-856 (HRPD) standards. A TDMA system can implement a radio technology such as global system for mobile communications (GSM), digital advanced mobile phone system (D-AMPS), etc. An OFDMA system can implement a radio technology such as evolved UTRA (E-UTRA), ultra mobile broadband (UMB), IEEE 802.16 (WiMAX), IEEE 802.20, Flash-OFDM®, etc. UTRA and E-UTRA are part of universal mobile telecommunication system (UMTS). 3GPP long term evolution (LTE) and LTE-Advanced (LTE-A) are new releases of UMTS that use E-UTRA. UTRA, E-UTRA, UMTS, LTE, LTE-A and GSM are described in documents from an organization named “3^{rd} Generation Partnership Project” (3GPP). CDMA2000 and UMB are described in documents from an organization named “3^{rd} Generation Partnership Project 2” (3GPP2). In an aspect, the cellular system 520 can include a number of base stations 522, which can support bi-directional communication for wireless devices within their coverage. Similarly, the cellular system 530 can include a number of base stations 532 that can support bi-directional communication for wireless devices within their coverage.

WLAN systems 540 and 550 can respectively implement radio technologies such as IEEE 802.11 (Wi-Fi), Hiperlan, etc. The WLAN system 540 can include one or more access points 542 that can support bi-directional communication. Similarly, the WLAN system 550 can include one or more access points 552 that can support bi-directional communication. The WPAN system 560 can implement a radio technology such as Bluetooth (BT), IEEE 802.15, etc. Further, the WPAN system 560 can support bi-directional communication for various devices such as wireless device 510, a headset 562, a computer 564, a mouse 566, or the like.

The broadcast system 570 can be a television (TV) broadcast system, a frequency modulation (FM) broadcast system, a digital broadcast system, etc. A digital broadcast system can implement a radio technology such as MediaFLO™, digital video broadcasting for handhelds (DVB-H), integrated services digital broadcasting for terrestrial television broadcasting (ISDB-T), or the like. Further, the broadcast system 570 can include one or more broadcast stations 572 that can support one-way communication.

The satellite positioning system 580 can be the United States Global Positioning System (GPS), the European Galileo system, the Russian GLONASS system, the quasi-zenith satellite system (QZSS) over Japan, the Indian Regional Navigational Satellite System (IRNSS) over India, the Beidou system over China, and/or any other suitable system. Further, the satellite positioning system 580 can include a number of satellites 582 that transmit signals for position determination.

In an aspect, the wireless device 510 can be stationary or mobile and can also be referred to as a user equipment (UE), a mobile station, a mobile equipment, a terminal, an access terminal, a subscriber unit, a station, etc. The wireless device 510 can be cellular phone, a personal digital assistance (PDA), a wireless modem, a handheld device, a laptop computer, a cordless phone, a wireless local loop (WLL) station, etc. In addition, a wireless device 510 can engage in two-way communication with the cellular system 520 and/or 530, the WLAN system 540 and/or 550, devices with the WPAN system 560, and/or any other suitable systems(s) and/or devices(s). The wireless device 510 can additionally or alternatively receive signals from the broadcast system 570 and/or satellite positioning system 580. In general, it can be appreciated that the wireless device 510 can communicate with any number of systems at any given moment. Also, the wireless device 510 may experience coexistence issues among various ones of its constituent radio devices that operate at the same time. Accordingly, wireless device 510 includes a coexistence manager (CxM, not shown) that has a functional module to detect and mitigate coexistence issues, as explained further below.

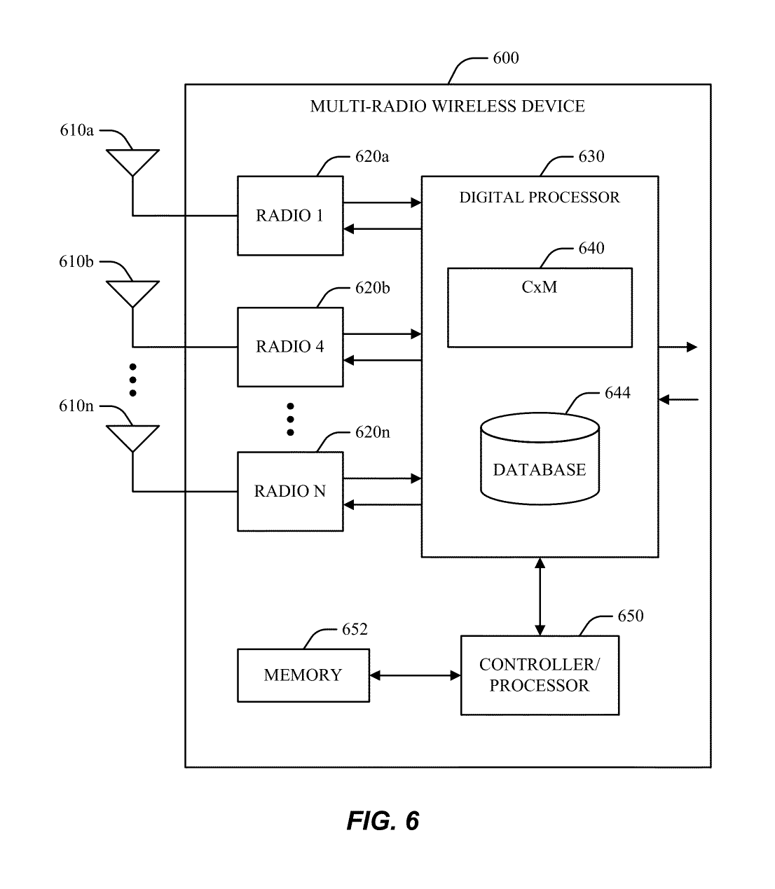

Turning next to FIG. 6, a block diagram is provided that illustrates an example design for a multi-radio wireless device 600 and may be used as an implementation of the radio 510 of FIG. 5. As FIG. 6 illustrates, the wireless device 600 can include N radios 620a through 620n, which can be coupled to N antennas 610a through 610n, respectively, where N can be any integer value. It should be appreciated, however, that respective radios 620 can be coupled to any number of antennas 610 and that multiple radios 620 can also share a given antenna 610.

In general, a radio 620 can be a unit that radiates or emits energy in an electromagnetic spectrum, receives energy in an electromagnetic spectrum, or generates energy that propagates via conductive means. By way of example, a radio 620 can be a unit that transmits a signal to a system or a device or a unit that receives signals from a system or device. Accordingly, it can be appreciated that a radio 620 can be utilized to support wireless communication. In another example, a radio 620 can also be a unit (e.g., a screen on a computer, a circuit board, etc.) that emits noise, which can impact the performance of other radios. Accordingly, it can be further appreciated that a radio 620 can also be a unit that emits noise and interference without supporting wireless communication.

In an aspect, respective radios 620 can support communication with one or more systems. Multiple radios 620 can additionally or alternatively be used for a given system, e.g., to transmit or receive on different frequency bands (e.g., cellular and PCS bands).

In another aspect, a digital processor 630 can be coupled to radios 620a through 620n and can perform various functions, such as processing for data being transmitted or received via the radios 620. The processing for each radio 620 can be dependent on the radio technology supported by that radio and can include encryption, encoding, modulation, etc., for a transmitter; demodulation, decoding, decryption, etc., for a receiver, or the like. In one example, the digital processor 630 can include a coexistence manager (C×M) 640 that can control operation of the radios 620 in order to improve the performance of the wireless device 600 as generally described herein. The coexistence manager 640 can have access to a database 644, which can store information used to control the operation of the radios 620. As explained further below, the coexistence manager 640 can be adapted for a variety of techniques to decrease interference between the radios. In one example, the coexistence manager 640 requests a measurement gap pattern or DRX cycle that allows an ISM radio to communicate during periods of LTE inactivity.

For simplicity, digital processor 630 is shown in FIG. 6 as a single processor. However, it should be appreciated that the digital processor 630 can include any number of processors, controllers, memories, etc. In one example, a controller/processor 650 can direct the operation of various units within the wireless device 600. Additionally or alternatively, a memory 652 can store program codes and data for the wireless device 600. The digital processor 630, controller/processor 650, and memory 652 can be implemented on one or more integrated circuits (ICs), application specific integrated circuits (ASICs), etc. By way of specific, non-limiting example, the digital processor 630 can be implemented on a Mobile Station Modem (MSM) ASIC.

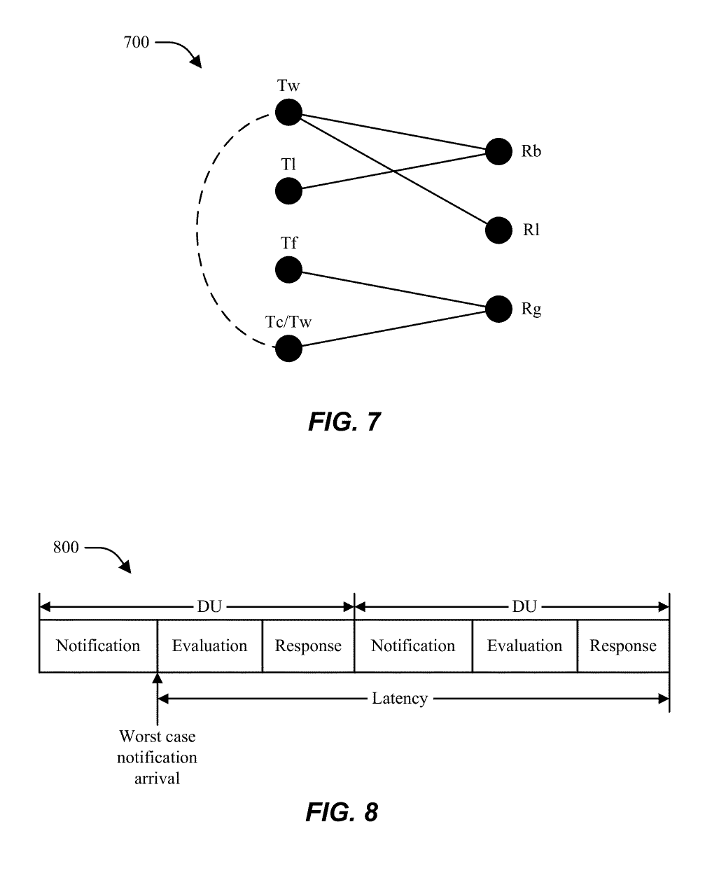

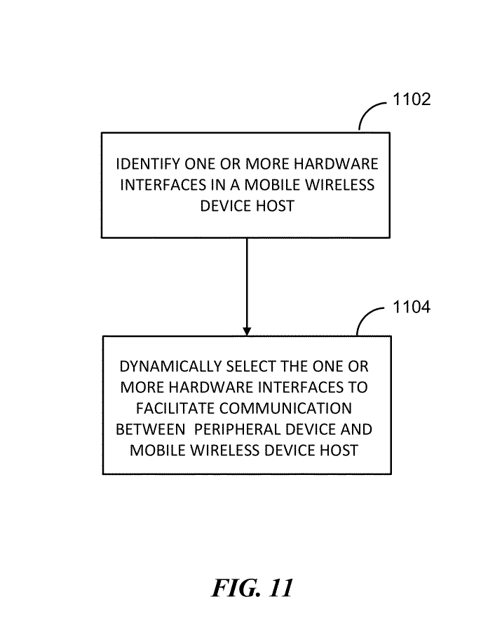

In an aspect, the coexistence manager 640 can manage operation of respective radios 620 utilized by wireless device 600 in order to avoid interference and/or other performance degradation associated with collisions between respective radios 620. Coexistence manager 640 may perform one or more processes, such as those illustrated in FIG. 11. By way of further illustration, a graph 700 in FIG. 7 represents respective potential collisions between seven example radios in a given decision period. In the example shown in graph 700, the seven radios include a WLAN transmitter (Tw), an LTE transmitter (T1), an FM transmitter (Tf), a GSM/WCDMA transmitter (Tc/Tw), an LTE receiver (R1), a Bluetooth receiver (Rb), and a GPS receiver (Rg). The four transmitters are represented by four nodes on the left side of the graph 700. The four receivers are represented by three nodes on the right side of the graph 700.

A potential collision between a transmitter and a receiver is represented on the graph 700 by a branch connecting the node for the transmitter and the node for the receiver. Accordingly, in the example shown in the graph 700, collisions may exist between (1) the WLAN transmitter (Tw) and the Bluetooth receiver (Rb); (2) the LTE transmitter (T1) and the Bluetooth receiver (Rb); (3) the WLAN transmitter (Tw) and the LTE receiver (R1); (4) the FM transmitter (Tf) and the GPS receiver (Rg); (5) a WLAN transmitter (Tw), a GSM/WCDMA transmitter (Tc/Tw), and a GPS receiver (Rg).

In one aspect, an example coexistence manager 640 can operate in time in a manner such as that shown by diagram 800 in FIG. 8. As diagram 800 illustrates, a timeline for coexistence manager operation can be divided into Decision Units (DUs), which can be any suitable uniform or non-uniform length (e.g., 100 μs) where notifications are processed, and a response phase (e.g., 20 μs) where commands are provided to various radios 620 and/or other operations are performed based on actions taken in the evaluation phase. In one example, the timeline shown in the diagram 800 can have a latency parameter defined by a worst case operation of the timeline, e.g., the timing of a response in the case that a notification is obtained from a given radio immediately following termination of the notification phase in a given DU.

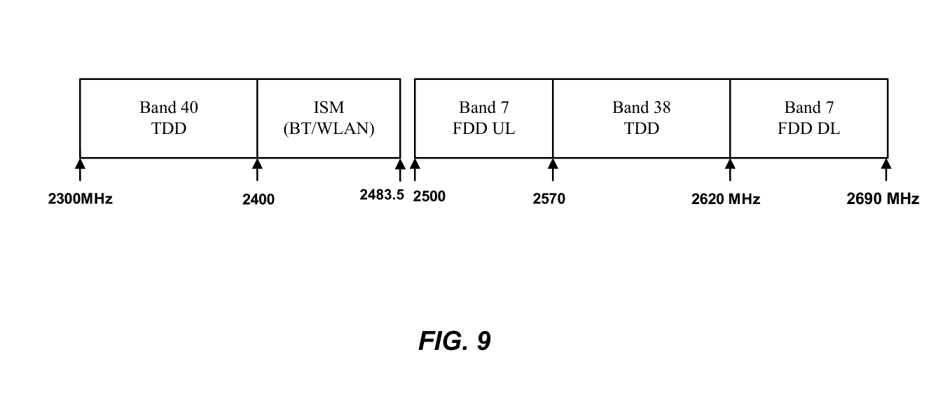

As shown in FIG. 9, Long Term Evolution (LTE) in band 7 (for frequency division duplex (FDD) uplink), band 40 (for time division duplex (TDD) communication), and band 38 (for TDD downlink) is adjacent to the 2.4 GHz Industrial Scientific and Medical (ISM) band used by Bluetooth (BT) and Wireless Local Area Network (WLAN) technologies. Frequency planning for these bands is such that there is limited or no guard band permitting traditional filtering solutions to avoid interference at adjacent frequencies. For example, a 20 MHz guard band exists between ISM and band 7, but no guard band exists between ISM and band 40.

To be compliant with appropriate standards, communication devices operating over a particular band are to be operable over the entire specified frequency range. For example, in order to be LTE compliant, a mobile station/user equipment should be able to communicate across the entirety of both band 40 (2300-2400 MHz) and band 7 (2500-2570 MHz) as defined by the 3rd Generation Partnership Project (3GPP). Without a sufficient guard band, devices employ filters that overlap into other bands causing band interference. Because band 40 filters are 100 MHz wide to cover the entire band, the rollover from those filters crosses over into the ISM band causing interference. Similarly, ISM devices that use the entirety of the ISM band (e.g., from 2401 through approximately 2480 MHz) will employ filters that rollover into the neighboring band 40 and band 7 and may cause interference.

In-device coexistence problems can exist with respect to a UE between resources such as, for example, LTE and ISM bands (e.g., for Bluetooth/WLAN). In current LTE implementations, any interference issues to LTE are reflected in the downlink measurements (e.g., reference signal received quality (RSRQ) metrics, etc.) reported by a UE and/or the downlink error rate which the eNB can use to make inter-frequency or inter-RAT handoff decisions to, e.g., move LTE to a channel or RAT with no coexistence issues. However, it can be appreciated that these existing techniques will not work if, for example, the LTE uplink is causing interference to Bluetooth/WLAN but the LTE downlink does not see any interference from Bluetooth/WLAN. More particularly, even if the UE autonomously moves itself to another channel on the uplink, the eNB can in some cases handover the UE back to the problematic channel for load balancing purposes. In any case, it can be appreciated that existing techniques do not facilitate use of the bandwidth of the problematic channel in the most efficient way.

### Dynamic Interface Selection in a Mobile Device

Current configurations of mobile broadband devices feature data exchange with a host or high level operating system. For example, the mobile broadband device (e.g., modem module) connects to the host application processor (e.g., x86 notebook) via a connector. The connector may include pins to accommodate different interfaces, such as a peripheral component interconnect express (PCIe), universal serial bus (USB), USB 3.0, superspeed inter chip (SSIC), high speed inter chip (HSIC) and the like. The choice of an interface is usually a single interface, which is determined statically during manufacturing of a mobile wireless device (e.g., notebook, ultrabook, and tablet) by an original equipment manufacturer, for example. However, the use of the single and static interface may be suboptimal. For example, the selected interface may be overprovisioned for the highest performance specifications, which may be undesired for practical implementations. Further, such predefined interfaces may lack flexibility that may be desired for varying communication conditions and device configurations.

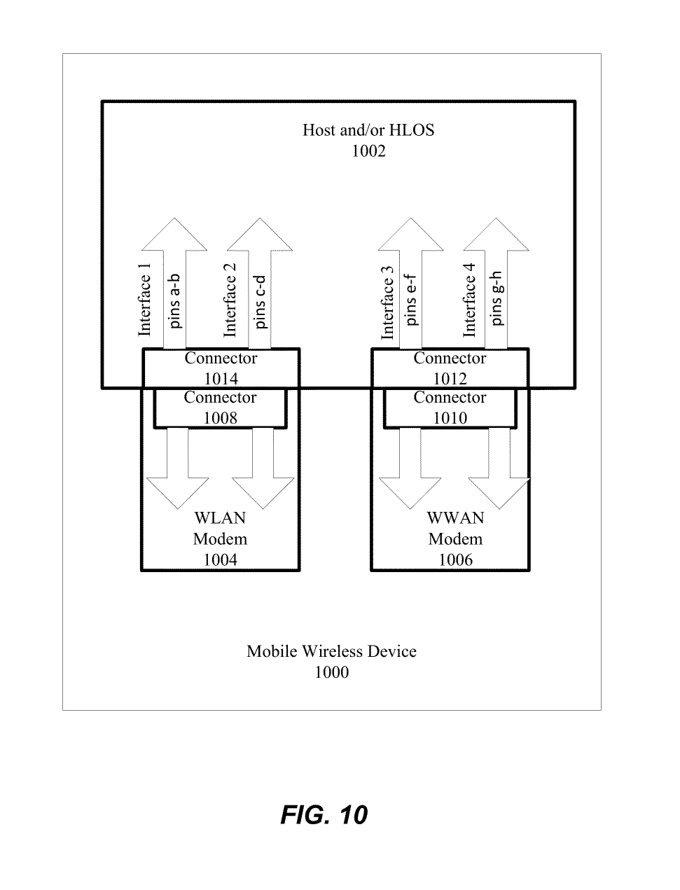

Proposed is a method for dynamically selecting or instantiating a desired interface. The interfaces may be dynamically selected/instantiated to improve conditions related to the mobile (multi-radio) wireless device, such as power consumption savings, radio coexistence mitigation, electromagnetic interference (EMI) reduction, etc. The method may be implemented in the mobile wireless device 1000 of FIG. 10.

FIG. 10 illustrates a mobile wireless device 1000 including a host coupled to one more wireless peripherals according to one aspect of the present disclosure. The mobile wireless device, such as an ultrabook, a notebook, a tablet, or other device, may include a computing platform/architecture-based host and/or high level operating system 1002, coupled to separate peripherals. The host 1002 may be, for example, an x86-based central processing unit architecture.

In one aspect of the disclosure, the separate peripherals may include a wireless local area network (WLAN) modem module 1004 and wireless wide area network (WWAN) modem module 1006 based on one or more standards (e.g., next generation form factor (NGFF) or surface mount technology (SMT)). The NGFF standard is also known as mini card version 2 (M.2). The standards may define the modem module's form factor and interface. For example, the NGFF/M.2 module standard is a connectorized standard while the SMT standard is a direct-solder standard.

The WLAN modem module 1004 and the WWAN modem module 1006 may be coupled to interfaces of the host 1002. In one aspect, the WLAN modem module 1004 and/or the WWAN modem module 1006 may be coupled to interfaces of the host via connectors 1008, 1010, 1012 and 1014 or other coupling means. In other aspects, the WLAN modem module 1004 and/or the WWAN modem module 1006 may be coupled to interfaces of the host via surface mount connections, such as solder balls or other functional modules where the components of the functional modules are coupled or connected to the host via conductive traces or other similar means.

In the illustration of FIG. 10, each of the WLAN modem module 1004 and the WWAN modem module 1006 are coupled to separate interfaces 1, 2, 3 and 4, where each interface is allocated to one or more pins, such as standard connector pins or pin assignments. For illustrative purpose, the interfaces 1, 2, 3 and 4 are shown extending from the modems 1004 and 1006, to the host 1002. Similarly, for illustrative purpose, the pin assignments are shown as different and separate from each other. For example, the interfaces 1 and 2 coupled to the WLAN modem module 1004 are allocated to pins a-b and c-d, respectively, while the interfaces, 3 and 4 coupled to the WWAN modem module 1006 are allocated to pins e-f and g-h, respectively. In some aspects of the disclosure, the interfaces associated with the WWAN modem module 1006 and the WLAN modem module 1004 may share pins rather than having specific pins allocated to each interface. For example, interfaces 1 and 3 may share one or more pins when the modem modules are identical.

The interfaces and the connectors/connections may be operable to facilitate communications, such as data plane communications, between the host 1002 and the modems 1004 and 1006. An example of a data plane communication is a low level detailed interaction between modems in order to effectuate radio management. Data plane communications may be implemented by the interfaces, such as a peripheral component interconnect express (PCIe), universal serial bus (USB), USB 3.0, superspeed inter chip (SSIC), high speed inter chip (HSIC) and the like. For example, interface 1 may be a PCIe, interface 2 may be a HSIC, interface 3 may be a PCIe and interface 4 may be a SSIC.

As noted, current interface selection techniques are based on a static selection. For example, when the device is powered up, the interface 1 is selected for the WLAN modem module 1004 and interface 4 is selected for the WWAN modem module 1006. Other current implementations only allow a single interface on the mobile wireless device.

Aspects of the current disclosure are based on one or more interfaces in the mobile wireless device. The introduction of multiple interfaces in a mobile wireless device or the introduction of a single configurable interface enables freedom in device portfolio management, whereby interface selection can be dynamic, static or pseudo-static, which may depend on a customer or user specifications. For example, an original equipment manufacturer and the corresponding host or high level operating system may specify a SSIC interface, while other mainstream plan of record (POR) interfaces are PCIe and HSIC. In some implementations, the mobile wireless device incorporates two or more interfaces per connection or connector. The two or more interfaces are dynamically selected according to aspects of the present disclosure to improve performance and user experience of the mobile wireless device 1000. Dynamically selecting between the interfaces may be based on operating conditions of the mobile wireless device 1000.

In one aspect the implementation of the dynamic interface selection may be based on software and/or hardware. For example, a software algorithm may select among two or more instantiated interfaces, in which the selection may be implemented in conjunction with a hardware multiplexer or selector. In other aspects, interface selection may be based on configurable hardware, such as a field programmable gate array (FPGA) or other configurable logic state machine, which may be configured by software to a desired interface permitted by the configurable hardware.

In one aspect of the disclosure, the interface may be selected based on power consumption conditions. In this aspect, the interface is selected based on its power consumption property. Certain interfaces demand more power than others do. The demand for power may correspond to an interface designed to accommodate higher data rate or for other performance related conditions. The use of a less complex interface when lower data rate is specified reduces power consumption. For example, under certain permitted conditions, the HSIC interface or universal asynchronous receiver/transmitter (UART) interface may be selected over the serializer/deserializer (SerDes) based PCIe interface or universal serial bus 3 (USB3) because power consumption is reduced with respect to the HSIC interface or UART interface.

In one aspect of the disclosure, the interface may be selected to mitigate radio coexistence and/or electromagnetic interference (EMI). High speed interfaces operate at GHz speeds that cause radio coexistence and EMI issues via both wired and wireless coupling methods. However, the impact of high speed wired interfaces are known to desense radio receivers through EMI coupling between traces and/or substrates. The desensing may occur wirelessly between antennas. The radio coexistence may be based on interference between radios (e.g., LTE and WLAN and/or Bluetooth (BT)). The ability to dynamically select between different interfaces improves performance of the mobile wireless device because different interfaces have different mitigating properties to reduce coexistence and/or EMI. Some interfaces, such as wired interfaces or interconnects (e.g., USB3), are known to cause more interference between radios than others. In addition, the wired interfaces may be subject to radiation, which further causes EMI issues. Thus, the ability to deselect such wired interfaces under these conditions and to dynamically select other interfaces according to aspects of the present disclosure may be preferable. A coexistence manager in the mobile wireless device may be configured to determine when the interference is problematic and to drive the interface selection based on the determination.

In one aspect of the disclosure, the interface may be selected based on specifications of an application. The application may have certain specifications, such as quality of service (QOS) that may require the preference of one interface over another. For example, an embedded display port (eDP) interface may be selected over a PCIe interface in the context of a streaming video. In this case, data exchange between a high frequency (e.g., 60 GHz) radio and the host 1002 may be via a PCIe interface while the streaming video exchange may be via the eDP interface. The eDP features may be part of the M.2 standard.

The mechanics of the dynamic interface selection may take different forms. In some implementations, the dynamic interface selection may be implemented external to the mobile wireless device through a wired connection or a wireless connection as well as via a specified mechanism, such as an application programming interface (API). The API may be configured to indicate, to a controller or developer/host, when to change from one interface to another or to select an interface. In some implementations, the dynamic interface selection may be implemented internal to the mobile wireless device via a controller, for example. In some aspects, the external and internal implementations may share a common or related API.

The dynamic interface selection may be between one or more existing or instantiated interfaces, such as existing PCIe and/or HSIC interfaces from which one is selected for use. In some aspects, a single interface can be instantiated to operate as a first interface or a different interface based on the conditions. This aspect may be based on an instantiation of one or more physical interfaces from a configurable system entity or configurable block, by configuring a physical entity to output the PCIe interface from a selection of potential interfaces. This feature may be useful to accommodate a connection or connector of limited pin count between two subsystems.

In one aspect, the dynamic interface selection may be based on a configuration or policy file. In this aspect, the interface may be selected or changed on boot-up of the mobile wireless device 1000 or dynamically in accordance with an over the air (OTA) implementation or through a wired connection by updating the policy file.

In one aspect, the interfaces may be dynamically selected based on a preference of a developer of the mobile wireless device or a silicon provider for the mobile wireless device, a user of the mobile wireless device, an application implemented on the mobile wireless device, and/or a protocol or an operating system of the mobile wireless device. For example, a user may prefer a particular interface, such as a USB interface associated with a USB protocol because of a long history of prior use within the user's company, for example.

In one aspect, the interfaces may be dynamically selected based on a protocol associated with an interface. For example, PCI express or USB protocols are used by different applications. Although the protocol associated with an interface and the interface are to some extent synonymous, there is a slight difference between the interface and the protocol. As a result, a protocol of one interface can be implemented on top of a different physical interface. For example, a USB protocol can run on top of Mobile Industry Processor Interface (MIPI) M-PHY physical layer associated with a SSIC interface. In addition, different operating systems may select different protocols based on current practice or legacy. For example, an original equipment manufacturer of an operating system may prefer an SSIC interface based on the availability of mobile broadband interface module (MBIM) protocol.

Dynamically selecting interfaces is beneficial to platforms or mobile wireless devices that include a peripheral (e.g., a wireless module) and a host, which exchange data or generic information. Although multiple interfaces include more pins than a single interface, dynamically selecting or switching between the multiple interfaces improves performance metric, like power, interference, or latency/jitter. Dynamically selecting interfaces can be applied to a system including a single host and/or a system including multiple hosts. Regarding the system including multiple hosts, one or more peripherals may be coupled or connected to each host to allow for host-to-host coupling or connectivity as well as host-to-host peripheral connectivity or coupling.

FIG. 11 illustrates a method of dynamically selecting an interface according to one aspect of the present disclosure. As shown in FIG. 11, the method starts with identifying one or more hardware interfaces in a mobile wireless device host, as shown in block 1102, and dynamically selecting the one or more hardware interfaces to facilitate communication between a peripheral device and the mobile wireless device host, as shown in block 1104.

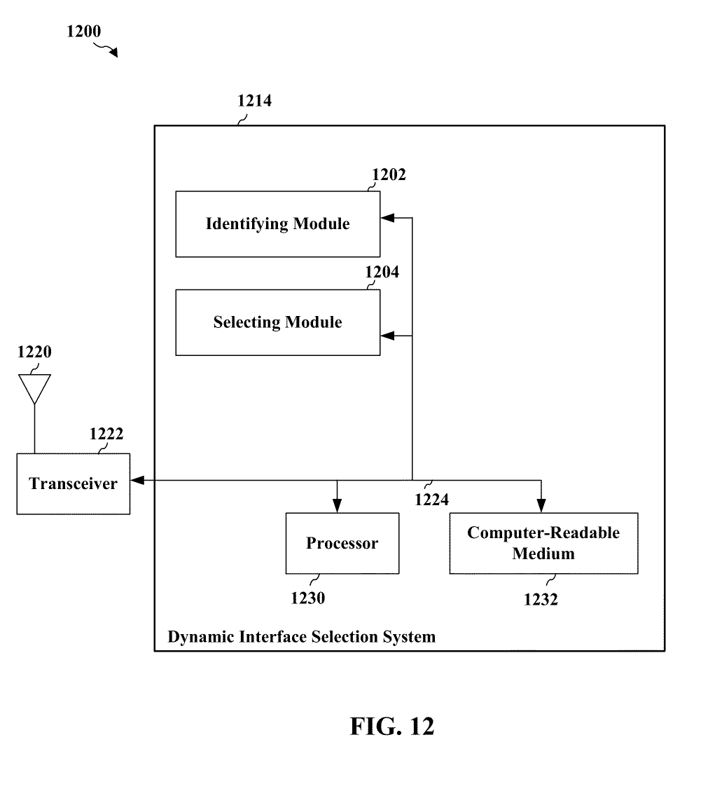

FIG. 12 is a diagram illustrating an example of a hardware implementation for an apparatus 1200 employing a dynamic interface selection system 1214. The apparatus 1200 may include an identifying module 1202 and a selecting module 1204. The dynamic interface selection system 1214 may be implemented with a bus architecture, represented generally by the bus 1224. The bus 1224 may include any number of interconnecting buses and bridges depending on the specific application of the dynamic interface selection system 1214 and the overall design constraints. The bus 1224 links together various circuits including one or more processors and/or hardware modules, represented by the processor 1230, the identifying module 1202, and the selecting module 1204, and the computer-readable medium 1232. The bus 1224 may also link various other circuits such as timing sources, peripherals, voltage regulators, and power management circuits, which are well known in the art, and therefore, will not be described any further.

The apparatus includes a dynamic interface selection system 1214 coupled to a transceiver 1222. The transceiver 1222 is coupled to one or more antennas 1220. The transceiver 1222 provides a means for communicating with various other apparatus over a transmission medium. The dynamic interface selection system 1214 includes a processor 1230 coupled to a computer-readable medium 1232. The processor 1230 is responsible for general processing, including the execution of software stored on the computer-readable medium 1232. The software, when executed by the processor 1230, causes the dynamic interface selection system 1214 to perform the various functions described above for any particular apparatus. The computer-readable medium 1232 may also be used for storing data that is manipulated by the processor 1230 when executing software. The dynamic interface selection system 1214 further includes the identifying module 1202 for identifying one or more hardware interfaces in a mobile wireless device host. The dynamic interface selection system 1214 may also include the selecting module 1204 for dynamically selecting the one or more hardware interfaces to facilitate communication between a peripheral device and the mobile wireless device host. The modules may be software modules running in the processor 1230, resident/stored in the computer-readable medium 1232, one or more hardware modules coupled to the processor 1230, or some combination thereof. The dynamic interface selection system 1214 may be a component of the eNB 100 and may include the memory 232 and/or at least one of the TX MIMO processor 220, transmit processor 230, the receive processor 270, and the controller/processor 650. The dynamic interface selection system 1214 may be a component of the UE 116 and may include the memory 232 and/or at least one of the TX MIMO processor 220, transmit processor 230, the receive processor 270, and the controller/processor 650.

In one configuration, the apparatus 1200 for wireless communication includes means for identifying and means for selecting. The aforementioned means may be one or more of the aforementioned modules of the apparatus 1200 and/or the dynamic interface selection system 1214 of the apparatus 1200 configured to perform the functions recited by the aforementioned means. As described above, the dynamic interface selection system 1214 may include the identifying module 1202, the selecting module 1204, TX MIMO processor 220, transmit processor 230, the receive processor 270, and the controller/processor 650. As such, in one configuration, the aforementioned means may be the identifying module 1202, the selecting module 1204, TX MIMO processor 220, transmit processor 230, the receive processor 270, and the controller/processor 650 configured to perform the functions recited by the aforementioned means.

The examples above describe aspects implemented in a host/modem interface. However, the scope of the disclosure is not so limited. Various aspects may be adapted for interfaces between subsystems in a device where more than one interface may be used under different circumstances. For example, a device including two or more subsystems, sometimes involving a connector between the subsystems, may specify different interfaces between the subsystems to meet the system or other specifications. In some cases, a single interface is designed for use, while in other cases additional interfaces may be available in the each subsystem and enabled for product use.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method of wireless communication comprising:
identifying one or more hardware interfaces in a mobile wireless device host; and
dynamically selecting the one or more hardware interfaces to facilitate communication between a peripheral device and the mobile wireless device host.

2. The method of claim 1, in which dynamically selecting further comprises:
dynamically or statically instantiating one or more hardware interfaces to facilitate communication between the peripheral device and the mobile wireless device host; and
dynamically or statically selecting the one or more interfaces in the mobile wireless device host based on the dynamic or static instantiation.

3. The method of claim 2, in which dynamically selecting further comprises, selecting based on a software algorithm between two or more instantiated interfaces in conjunction with a multiplexer or selector.

4. The method of claim 2, in which dynamically selecting further comprises, selecting between two or more instantiated interfaces based on configurable hardware.

5. The method of claim 2, further comprising:
identifying a policy that determines the selection and/or instantiation of the one or more interfaces; and
dynamically or statically selecting and/or instantiating the one or more interfaces in the mobile wireless device host based on the policy.

6. The method of claim 5, in which the policy is based on one or more of an application configured to run on the mobile wireless device host, a customer specification, an original equipment manufacturer, a protocol, a history of prior use and/or a metric.

7. The method of claim 6, in which the metric includes power consumption in the one or more interfaces, throughput, latency, jitter, interference, radio coexistence and/or electromagnetic interference within the mobile wireless device host based on the selected and/or instantiated interface.

8. The method of claim 5, in which the policy is implemented as a database of settings and/or as an application programming interface.

9. The method of claim 5, in which the policy is updated via wired connection or wireless connection.

10. An apparatus for wireless communication comprising:
means for identifying one or more hardware interfaces in a mobile wireless device host; and
means for dynamically selecting the one or more hardware interfaces to facilitate communication between a peripheral device and the mobile wireless device host.

11. An apparatus for wireless communication comprising:
a memory; and
at least one processor coupled to the memory and configured:
to identify one or more hardware interfaces in a mobile wireless device host; and
to dynamically select the one or more hardware interfaces to facilitate communication between a peripheral device and the mobile wireless device host.

12. The apparatus of claim 11, in which the at least one processor is further configured to dynamically select by:
dynamically or statically instantiating one or more hardware interfaces to facilitate communication between the peripheral device and the mobile wireless device host; and
dynamically or statically selecting the one or more interfaces in the mobile wireless device host based on the dynamic or static instantiation.

13. The apparatus of claim 12, in which the at least one processor is further configured to dynamically select by selecting based on a software algorithm between two or more instantiated interfaces in conjunction with a multiplexer or selector.

14. The apparatus of claim 12, in which the at least one processor is further configured to dynamically select by selecting between two or more instantiated interfaces based on configurable hardware.

15. The apparatus of claim 12, in which the at least one processor is further configured:
to identify a policy that determines the selection and/or instantiation of the one or more interfaces; and
to dynamically or statically select and/or instantiate the one or more interfaces in the mobile wireless device host based on the policy.

16. The apparatus of claim 15, in which the policy is based on one or more of an application configured to run on the mobile wireless device host, a customer specification, an original equipment manufacturer, a protocol, a history of prior use and/or a metric.

17. The apparatus of claim 16, in which the metric includes power consumption in the one or more interfaces, throughput, latency, jitter, interference, radio coexistence and/or electromagnetic interference within the mobile wireless device host based on the selected and/or instantiated interface.

18. The apparatus of claim 15, in which the policy is implemented as a database of settings and/or as an application programming interface.

19. The apparatus of claim 15, in which the policy is updated via wired connection or wireless connection.

20. A computer program product for wireless communications in a wireless network:
a computer-readable medium having program code recorded thereon, the program code comprising:
code to identify one or more hardware interfaces in a mobile wireless device host; and
code to dynamically select the one or more hardware interfaces to facilitate communication between a peripheral device and the mobile wireless device host.
